(19) United States
(12) Patent Application Publication
(10) Pub. No.: US 2015/0134459 A1
(43) Pub. Date: May 14, 2015

(54) SYSTEM AND METHOD FOR USING MOBILE DEVICES TO CREATE SECURITIZED LOCALLY DEPLOYED SIGNALS TO DELIVER VALUE

(71) Applicant: INMARKET MEDIA LLC, Venice, CA (US)

(72) Inventor: Todd J. Dipaola, Venice, CA (US)

(21) Appl. No.: 14/601,959

(22) Filed: Jan. 21, 2015

Related U.S. Application Data
(63) Continuation-in-part of application No. 13/379,909, filed on Jul. 23, 2013.
(60) Provisional application No. 61/421,380, filed on Dec. 9, 2010.
(60) Provisional application No. 61/421,380, filed on Dec. 9, 2010.

(51) Int. Cl. G06Q 30/02

(52) U.S. Cl. CPC G06Q 30/0267
USPC 705/14.64

(57) ABSTRACT

A system and method for using mobile devices to create securitized locally deployed signals to deliver value are disclosed. A particular embodiment includes: detecting a trigger event in a location, by a data processor in a first mobile device without the use of a stationary transmission device at the location; initiating a local broadcast of a signal from the first mobile device in the location in response to the trigger event, the signal including a value offering; and receiving the signal at a second mobile device in the location.

### PRIORITY PATENT APPLICATIONS

This is a continuation-in-part patent application claiming priority from co-pending U.S. patent application Ser. No. 13/379,909; filed Jul. 23, 2013, which is a National Stage Entry of PCT/US11/01962; filed Dec. 9, 2011, which claims priority from U.S. provisional patent application Ser. No. 61/421,380; filed Dec. 9, 2010. This present non-provisional continuation-in-part patent application draws priority from the referenced patent applications. The entire disclosure of the referenced patent applications is considered part of the disclosure of the present application and is hereby incorporated by reference herein in its entirety.

### TECHNICAL FIELD

This patent application relates to data processing hardware, static and mobile computing and communication devices, computer-implemented software, and networked systems, according to one embodiment, and more specifically to a system and method for using mobile devices to create securitized locally deployed signals to deliver value.

### COPYRIGHT

A portion of the disclosure of this patent document contains material that is subject to copyright protection. The copyright owner has no objection to the facsimile reproduction of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2012-2015 inMarket Media LLC, All Rights Reserved.

### BACKGROUND

Currently, people are taking their mobile electronic devices everywhere with them in their daily lives. Therefore, uses and applications of mobile electronic devices are increasing at a rapid pace to accommodate people anywhere throughout their normal daily routines. Users of mobile electronic devices are also consumers and many of the new uses and applications of mobile electronic devices are in some manner associated with the consumer activity of users. In some instances, a consumer may opt to use the mobile electronic device during consumer activity at a location.

Conventional systems exist for interacting with users' mobile devices in a location to convey signals including information, advertising, or coupons to the mobile devices. These systems often require the physical installation of a device at locations capable of broadcasting such signals at the location. However, it is not always feasible or cost-effective install or operate a signal transmitter, often known as a beacon, at the location. Additionally, the security of the transmissions or even the mere presence of these signals can cause a security breach.

### BRIEF DESCRIPTION OF THE DRAWINGS

The various embodiments are illustrated by way of example, and not by way of limitation, in the figures of the accompanying drawings in which:

FIG. 1 illustrates an example embodiment of a value delivery system in a network-enabled ecosystem;

FIG. 2 illustrates an example embodiment of the value delivery system in which a seed mobile device can transmit signals to other mobile devices via the mobile device value delivery system;

FIG. 3 illustrates an example embodiment of the value delivery system in which a seed mobile device can terminate the transmission of signals to other mobile devices;

FIG. 4 illustrates an example embodiment of the value delivery system in which a mobile device can transmit decoy signals to other mobile devices;

FIGS. 5 and 6 are processing flow charts illustrating example embodiments of methods as described herein; and

FIG. 7 shows a diagrammatic representation of machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

The various embodiments described herein provide a system and method for using mobile devices to create locally transmitted and replicated signals to deliver value. Mobile devices deployed or operating in a particular physical location can be configured to generate signals at the particular location when a seed mobile device experiences a trigger event. The generated signals can be used to add value or provide a value offering on mobile devices and to forward or replicate signals to other proximate mobile devices to thereby transfer information, value, or both to a plurality of mobile devices at the particular location. Value from such signals can range from advertising, coupons, application (app) functionality (e.g., reminders, etc.), loyalty points, creating a record of visits for marketing conversions or remarketing as described in more detail below, or any combination these. The signal may contain data and may correspond with one or more of a particular location, a type of location, or a condition at the location. As a result, value can be provided and shared at that location among a number of mobile devices that can form an ad-hoc information and value sharing community. In addition, value can be provided as part of a chain of events stretching before a mobile device enters a location to after the mobile device leaves the location. Because any of the mobile devices in the location may act as the seed mobile device, the various embodiments enable the formation of the ad-hoc information and value sharing community of mobile devices without the need for the physical installation of a device at the location capable of broadcasting signals at the location. As described in more detail below, the various embodiments disclosed herein are different from standard secure local area networks (LANs) for a variety of reasons. For example, the various embodiments herein do not need a central router or a central control mechanism. The various embodiments can spontaneously form (or shut down) an ad-hoc information and value sharing community among a plurality of mobile devices based on event triggers in a location. As a result of the event triggered action, the various embodiments can save and extend battery life in the connected mobile devices. The various embodiments also do not require the installation of permanent hardware to support the network. As such, the cost of supporting the self-perpetuating, non-centralized, ad-hoc information and value sharing community of the various example embodiments is virtually nil.

The various embodiments described herein provide a value delivery system that includes a combination of hardware, software, and processes. The hardware provides a communication and software platform and multi-modal communication interfaces to support the software and human processes. A particular embodiment can include or use a variety of conventional mobile devices with a computing system therein configured in the novel manner as described herein. As described in more detail below, the mobile device or computing system on which the described embodiments can be implemented can include personal communication devices (e.g., cellular telephones, smartphones, or other wireless devices), portable computing devices, laptops, tablet computers, personal digital assistants (PDAs), wearable computing devices, network computers, web appliances, networking devices, routers, gateways, personal computers (PCs), set-top boxes, consumer electronic devices, vehicle electronic systems, or any other type of computing, data processing, communication, networking, or electronic system.

An example embodiment includes a mobile device with multiple communication and functionality options with multi-modal communication interfaces (e.g., voice, text, email, Bluetooth, Bluetooth Low Energy, WiFi, imaging or scanning functionality, etc.). Bluetooth is a wireless technology standard for exchanging data over short distances using short wavelength, ultra-high frequency (UHF) radio waves. WiFi is a local area wireless technology that allows an electronic device to exchange data or connect to the internet using UHF or super high frequency (SHF) radio waves. Near-field or nearfield communication (NFC) is a form of short-range wireless communication where the antenna used is much smaller than the wavelength of the carrier signal. Bluetooth, Bluetooth Low Energy, WiFi, and NFC technologies are well-known to those of ordinary skill in the art.

The software of the various embodiments described herein builds on the capabilities of the hardware to enable the configuration of the mobile devices and to enable the formation of the ad-hoc information and value sharing community of mobile devices. In various example embodiments described in detail below, a software application program (app) executing with the computing environment of a mobile device is used to configure the mobile device to sense trigger events, communicate with a wide area network, generate or receive information or value signals, implement various security protocols, and forward the information and value signals to other proximate mobile devices. In alternative embodiments, software or firmware executing at an operating system (OS) level or at a device hardware level can also be used to implement the value delivery system. The value delivery system of an example embodiment implements a trusted computing environment in which individual authentication is enforced and information sharing can be controlled in a granular way to specifically configure the information that is shared and how the information is shared among mobile devices and the users thereof. The software functionality and the processes implemented in various example embodiments are described in more detail below.

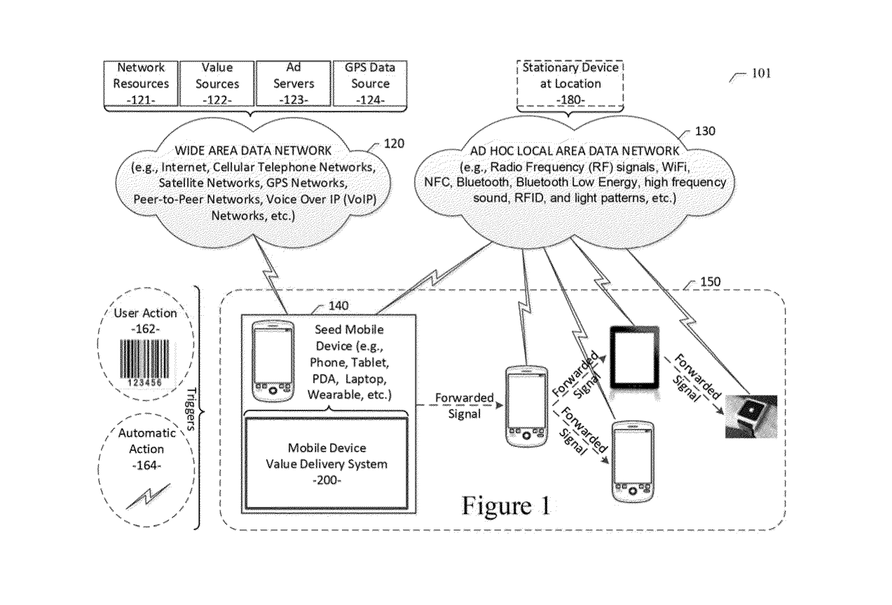

Referring now to FIG. 1, in an example embodiment, a system 101 for using mobile devices to create locally deployed and replicated signals to deliver value in a network-enabled ecosystem is disclosed. In a particular embodiment, a mobile device value delivery system 200, or a portion thereof, can be downloaded from a network resource 121 (such as a server) via wide area network 120 and installed for execution locally within an executable environment on a mobile device 140. The downloading of the value delivery system 200 (or a portion thereof) can be accomplished using conventional software downloading functionality. In alternative embodiments, the software or firmware implementing the value delivery system 200 can be pre-installed at an application level, an OS level, or at a device hardware level. As a second option, the value delivery system 200 can be hosted wholly or in part by a host site at a network resource 121 and executed remotely, from the user's perspective, on the host site. In a particular embodiment, the value delivery system 200 can be implemented as a service in a service-oriented architecture (SOA) or in a Software-as-a-Service (SAAS) architecture. In any case, the functionality performed by the value delivery system 200 is as described herein, whether the application is executed locally or remotely, relative to the user. The details of the value delivery system 200 of an example embodiment are provided below.

Network 120 is configured to couple one computing or communication device with another computing or communication device over a wide area. Network 120 may be enabled to employ any form of computer readable media for communicating information from one electronic device to another. Network 120 can include the Internet, wide area networks (WANs), local area networks (LANs), cellular telephone networks, satellite networks, global positioning satellite (GPS) networks, peer-to-peer networks, Voice over IP (VoIP) networks, etc. Network 120 may further employ any of a plurality of well-known access technologies including 2nd (2G), 2.5, 3rd (3G), 4th (4G) generation radio access for cellular systems, and the like. Access technologies such as 2G, 3G, 4G, and future access networks may enable wide area coverage for mobile devices, such as one or more of mobile devices 140, with various degrees of mobility. For example, network 120 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. Network 120 may also be constructed for use with various other wired and wireless communication protocols, including TCP/IP, UDP, SIP, SMS, RTP, WAP, CDMA, TDMA, EDGE, UMTS, GPRS, GSM, UWB, WiFi, WiMax, IEEE 802.11x, and the like. In essence, network 120 may include virtually any wired and/or wireless communication mechanisms by which information may travel between one computing or communication device and another computing or communication device, network, and the like.

The value delivery system 200 of an example embodiment can be implemented to be compatible with any form of network transportable digital data. The network transportable digital data can be transported in any of a group of data packet or file formats, protocols, and associated mechanisms usable to enable a network resource 121 to transfer data to mobile device 140 over network 120. In one embodiment, the data format for the value delivery system 200 can be HyperText Markup Language (HTML). HTML is a common markup language for creating web pages and other information that can be displayed in a web browser. In another embodiment, the data format can be Extensible Markup Language (XML). XML is a markup language that defines a set of rules for encoding information in a format that is both human-readable and machine-readable. In another embodiment, a JSON (JavaScript Object Notation) format can be used to transfer information among mobile devices 150. JSON is a text-based open standard designed for human-readable data interchange. The JSON format is often used for serializing and transmitting structured data over a network connection. JSON can be used in an embodiment to transmit data between a server, device, or application, wherein JSON serves as an alternative to XML. The Hypertext Transfer Protocol (HTTP) or secure HTTP (HTTPS) can be used as a network data communication protocol. In one embodiment, a browser application can be enabled to employ HyperText Markup Language (HTML), Dynamic HTML, Handheld Device Markup Language (HDML), Wireless Markup Language (WML), WMLScript, JavaScript, EXtensible HTML (xHTML), Compact HTML (CHTML), and the like, to display and/or send digital information. In other embodiments, mobile devices can be configured with applications (apps) with which the functionality described herein can be implemented.

Referring again to FIG. 1, the value delivery system 200 can be in network communication with a plurality of sites via network 120. As described above, the value delivery system 200 can be in network communication with a plurality of network resources 121. Network resources 121 can represent the network locations of a host site, system administrators, affiliates, information sources, or other contacts or network resources that may provide or consume data associated with the value delivery system 200 of the example embodiment. The value delivery system 200 can also be in network communication via network 120 with a plurality of value sources 122. Value sources 122 can represent the network locations of advertisers, coupon providers, app functionality providers, loyalty program managers, marketing sites, conversion tracking sites, or the like. Value sources 122 can serve as the originators of the value dispersed or offered among a plurality of mobile devices in an ad-hoc information and value sharing community of mobile devices 150. Value sources 122 can also serve as data aggregators and value facilitators. The value originated, facilitated, or logged by value sources 122 need not be dispersed to the user immediately. The value sources 122 can create value, for example, simply by logging data to be used in future advertising or conversion activities. The value delivery system 200 can also be in network communication via network 120 with a plurality of ad servers 123. Ad servers 123 can represent the network locations of sources of advertising content that may be served to the plurality of mobile devices in the ad-hoc information and value sharing community of mobile devices 150. The value delivery system 200 can also be in network communication via wide area data network 120 with a plurality of GPS or geographical location (geo-location) data sources 124. GPS data sources 124 can represent the network locations of sources of geo-location data to enable a mobile device of the ad-hoc information and value sharing community of mobile devices 150 to determine a current geo-location. Alternatively, a mobile device 150 can use a well-known internal GPS receiver to obtain geo-location data directly from a GPS satellite network. In any case, each mobile device of the ad-hoc information and value sharing community of mobile devices 150 may determine its current geo-location using conventional technology.

Referring still to FIG. 1, the mobile devices of the ad-hoc information and value sharing community of mobile devices 150 can also communicate within a configured proximity zone via an ad-hoc local area data network 130. Ad-hoc local area data network 130 can be implemented using any of a variety of well-known local data communication technologies, such as radio frequency (RF) signals, WiFi, NFC, Bluetooth, Bluetooth Low Energy, high frequency sound, RFID, and light patterns, etc. Any of these local data communication technologies can be used to transfer data between mobile devices physically located within pre-configured distances (e.g., proximately located). The configured proximity zone may be configured for broadcasting at different power levels to add a desired level of granularity to the proximity zone. Thus, proximately located mobile devices 150 can communicate via ad-hoc local area data network 130 while the mobile devices are physically close to each other, such as within a business location.

Referring again to FIG. 1, the value delivery system 200 can be in network communication with a stationary device 180 at a particular location via ad-hoc local area data network 130. The stationary device 180 can represent the physical installation of a signal transmitting device at a location, for example, wherein the stationary device 180 is capable of broadcasting signals at the location. In many of the example embodiments described herein, the presence of the stationary device 180 at a particular location is not required. Thus, the stationary device 180 is shown in FIG. 1 with dashed lines. Nevertheless, some of the example embodiments described herein can use the stationary device 180 if such a device is present at the particular location.

Referring again to FIG. 1, value delivery system 200 of an example embodiment is shown as installed for execution locally within an executable environment on the mobile device 140. The value delivery system 200 of an example embodiment can be implemented as a software component executing within the mobile device 140 and stored within a non-transitory memory (e.g., FLASH memory, EEPROM, EPROM, PROM, or the like) therein. As described above for an alternative embodiment, the value delivery system 200 can be hosted wholly or in part on a host site at a network resource 121 and executed remotely on the host site. The operation of the value delivery system 200 of an example embodiment is described in more detail below in connection with the figures provided herein.

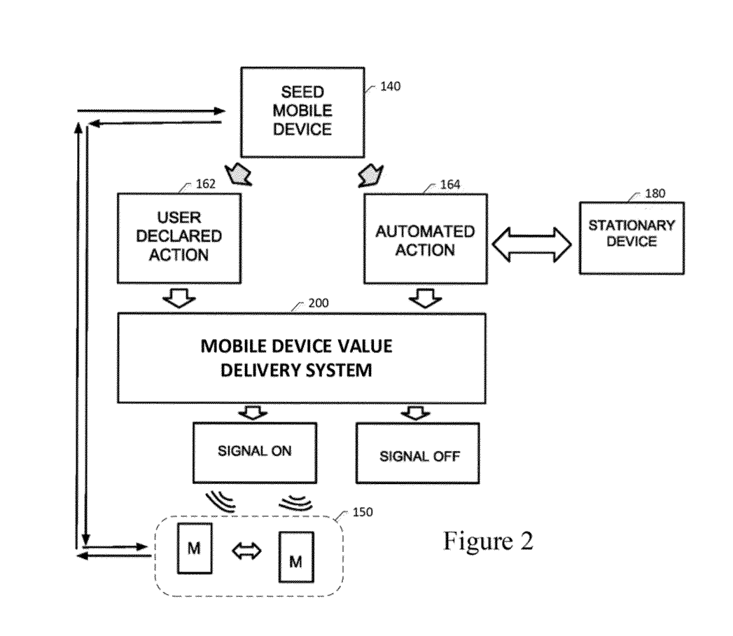

Referring to FIGS. 1 and 2 for an example embodiment, one or more mobile devices 150 can be present in or may enter a particular physical location. One or more of the mobile devices 150 can include or have access to the value delivery system 200 of the example embodiment described herein. Additionally, one or more of the mobile devices 150 can receive information that indicates a trigger event. Such trigger events can include mobile device user initiated events 162, such as the user scanning a barcode or a two-dimensional barcode (e.g., a QR code), with the mobile device to get product information or pricing at the location, the user explicitly providing a user input, the user purchasing an item, the user initiating check in or check out at the location, or a variety of other user-initiated events. The trigger events can also include automatic (non-user-initiated) events 164, such as the receipt of a particular signal from a transmitter at the location, the detection of a particular geo-location or geo-location boundary, being present within a pre-determined time/date window, being a pre-determined customer number, or a variety of other automatic events. Extrinsic data, such as date, time, and geo-location can also be used to condition or qualify the trigger events. In general, the trigger events can be any one or more of a variety of factors that provide certainty of the presence of the mobile device at the particular location. The value delivery system 200 within the mobile device can be configured to enable a particular trigger event based on a set of pre-defined conditions. The trigger events can also include the receipt of a signal from another mobile device or the stationary device 180 via ad-hoc local area data network 130. In this case, a signal from a stationary device 180 and/or another mobile device 150 can activate another mobile device 150 and so forth, setting off a chain reaction of signals throughout the location. There can also be local intermediaries that transmit or prolong the effect of such a signal, such as a wireless router.

Upon receipt of one or more triggers 162/164, a particular mobile device 150 can assume the role of the seed mobile device 140. The seed mobile device 140 can begin broadcasting signals in a given space and/or time to proximate mobile devices 150 via any of the data communication technologies provided by network 130. As a result, an ad-hoc local area data network 130 can be spontaneously created between two or more mobile devices in response to the receipt of one or more trigger events 162/164 by the seed mobile device 140. In an alternative embodiment, a two-way communication between the seed mobile device 140 and the proximate mobile devices 150 can be initiated. The signal from the seed mobile device 140 can reach a proximate mobile device 150 and ultimately cause information and/or value to be delivered or offered to other mobile devices 150 as shown in FIG. 1. Because the mobile devices 150 can include or have access to the value delivery system 200 of the example embodiments described herein, the signal from the seed mobile device 140 can also be forwarded to downstream mobile devices 150, so the information and/or value can be delivered to a plurality of mobile devices 150 in the location. To determine and/or verify the value to be delivered, the seed mobile device 140 may communicate variety of information including, but not limited to, a part of or an abstraction of the signal itself, GPS coordinates, other signals in range, user information, a timestamp, and other data. The seed mobile device 140 may also initiate an access to a network resource 121, a value source 122, an ad server 123, or the like via network 120 to convey or obtain information related to the information or value being delivered to the other mobile devices 150. The seed mobile device 140 may also communicate with a network resource 121, a value source 122, an ad server 123, or the like to get an instruction list, which defines how, when, and what information and/or value to convey or offer. Alternatively, the seed mobile device 140 may rely on a locally stored set of instructions defining how, when, and what information and/or value to convey or offer. As described above, the value originated, facilitated, or logged by the network resource 121, the value source 122, the ad server 123, or the like need not be dispersed to the user immediately. The value can be created, for example, simply by logging data to be used in future advertising or conversion activities.

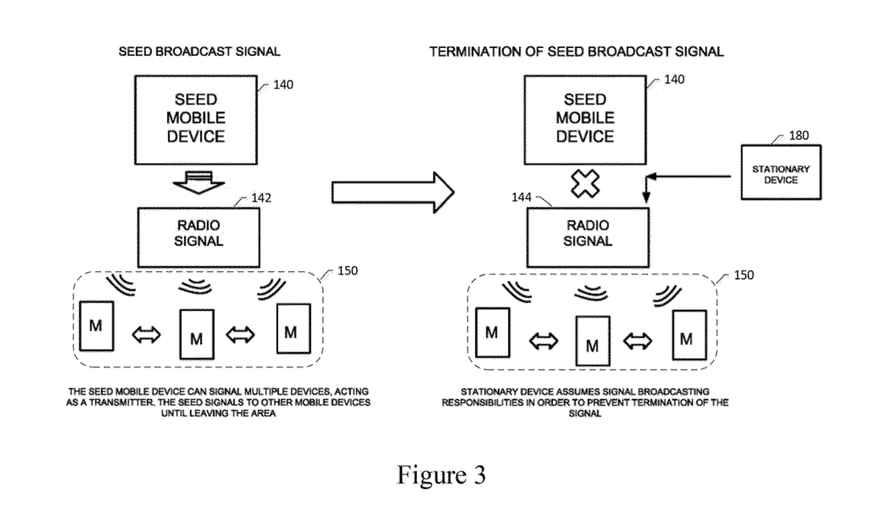

To better control the accuracy and security of the local network created among the mobile devices 150 by the value delivery system 200 of an example embodiment, a number of security enhancements may also be provided according to various embodiments. One enhancement is the intelligent ending or termination of the signal that is broadcast from each mobile device 150 via ad-hoc local area network 130. This signal termination feature of an example embodiment, as shown in FIG. 3, limits the signal from being carried into locations outside of the original location. Referring to FIG. 3, a seed mobile device 140 may be transmitting local signals 142 to other proximate mobile devices 150 as described above. These signal transmissions may be terminated upon the occurrence of one or more termination events, such as a pre-determined time threshold being reached, the seed mobile device 140 moving a pre-determined distance away from the initial location, accelerating to a pre-determined speed indicating travel, completing a checkout at a store at the location, or any of a variety of other termination events. There can also be a GPS geo-fence, the transition of which can create a termination event, which will shut down the signal transmission after a certain distance, frequency, or unique device count threshold is reached from either the last signal location or the point at which the first seed mobile device 140 transmitted the signal. As shown in FIG. 3, a particular embodiment can use a stationary transmitting device 180, if one is available at the location, to continue transmission of the signal 144 if the seed mobile device 140 has terminated its signal transmission.

Another enhancement is to secure the signals in such a way that access, interpretation, and/or replication of the network is only accessible to an authorized device and is not accessible to an outside party. To accomplish this, the data encoded in the signal transmitted by the seed mobile device 140 or downstream mobile devices 150 may be modulated at varying intervals so as to be unpredictable. This modulation may be generated by a pre-defined process in the value delivery system 200, or use stored codes from the mobile device 150 or a network resource 121. In addition, the stored codes may be unique in several ways. The codes may be unique in regard to a variety of factors, including but not limited to, the geo-location of the mobile device 150, the current date/time, the identifier of the mobile device 150 from which the signal was received, the app that generated the signal, and/or the specific device/user that generated the signal. In one embodiment, the first seed mobile device 140 at a location may begin by generating a first code; each subsequent mobile device 150 triggered may generate a new code, or the mobile device 150 may rebroadcast the original code. Over time, such as seconds, minutes, or days later, the signal codes may again be modulated differently. In this way, unauthorized parties will not know the current code and to what the code corresponds without authorized access to the local network. In addition, a rogue party attempting to trigger events on network devices will not know the appropriate code to generate a seed code and begin a chain reaction of signals.

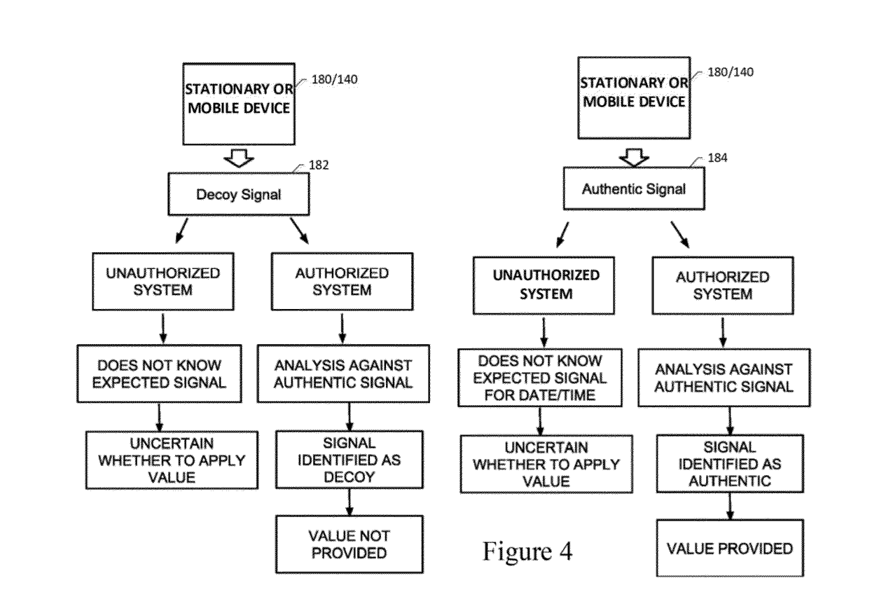

Because the mere presence of any signal in an environment, even without deciphering its content, could reveal a location of interest, the value delivery system 200 of an example embodiment may include a decoy generation and broadcast system. This feature of an example embodiment, as shown in FIG. 4, enables mobile devices 150 to broadcast decoy signals 182 when the mobile devices 150 are not in a particular location where value signals are being broadcast. Unauthorized devices or systems that receive the decoy signals will not be able to obtain value based on the decoy signals. Authorized devices and systems that receive the decoy signals will be able to identify the received signals as decoy signals and will not approve the delivery of value, deliver data, or record data. Conversely, unauthorized devices that receive the authentic (value delivering) signals will not be able to identify the received signals as authentic signals and thus cannot approve the delivery of value. Authorized devices that receive the authentic signals will be able to identify the received signals as authentic signals and will approve the delivery of value. Mobile devices 150 may be configured to periodically transmit and or retransmit a signal, including a seed signal, which does not correspond to any particular location. Additionally, mobile or fixed devices, such as a wireless router, might pick up and rebroadcast or modulate the signal. This may be done in concert with a server on the internet, or through local stored instructions. In one such embodiment, an office worker's mobile device might begin transmitting such a decoy signal while s/he is at work and other proximate mobile devices or fixed transmitting devices might pick up the decoy signal and form a decoy network. In this manner, any outside party looking to identify a location merely by the presence or density of signals, even without knowing the meaning of the signals, will not be successful.

Yet another security feature of the value delivery system 200 of an example embodiment is the ability to sense other signals in a particular location. These sensed signals may include already installed signals (authorized signals) as well as signals being transmitted without the consent of a responsible party at the particular location (unauthorized signals). The network of mobile devices 150 and servers may function as a detection network to identify any unauthorized signal transmissions at the particular location. The network may use this data as a shield to alert a location as to the presence of unauthorized signals, or the data may be used to map the authorized signals and their variables, such as GPS and/or MAC address for use by the network for generating value. In this way, multiple mobile devices may form a viral signal network identifying a location without the need to install permanent hardware at that location. The presence of the network can be transparent and automatic to users. In one embodiment, a shopper walking into a store might interact with their mobile device by scanning a product barcode for rewards points. This user action is a trigger event causing her mobile device to begin transmitting an initial seed signal via the ad-hoc local area network 130. That seed signal may in turn trigger other mobile devices 150 in the vicinity to begin signaling as well. Even after the first shopper leaves the store location, the network of other mobile devices 150 inside the store location can perpetually sustain the signal longer, although it may modulate over time. In this way, the network can activate location signals even without having physical devices installed inside the store location. In yet another embodiment, a concert attendee at a festival may tag a picture with precise GPS coordinates, which creates a seed signal. Then, the mobile devices of other concert goers around him may begin signaling each other in the manner described above. In yet another embodiment, a fan at a baseball stadium may check statistics on the current batter. The combination of GPS plus user action triggers another seed signal, which is replicated throughout the stadium by the mobile devices of other fans in the stadium. In yet another embodiment, a shopper walking into a store may have the mobile device passively recognize an existing signal, such as the MAC address of the store's internal WiFi network. The passive signal recognition creates an automatic trigger, which causes the mobile device to generate a seed signal in the manner described above.

The value of the mobile device signal network of the example embodiments as described herein has many components to different stakeholders. Advertisers are able to reach users in these locations either actively, such as through the use of push messages, as well as passively through more targeted advertising as a user is on their device in the future, such as viewing more customized banner ads. For users, the value can be in enhanced app context. For example, all users at the baseball game in certain apps may pick up the signal and receive real time sports scores. Shoppers in store might receive special promotions or coupons for the store they are in, or even a competitive store. Users can also receive reminders or calls to action for the location they are in, such as shopping list reminders for the store or concert lineup times at the festival. Application makers gain the ability to provide better services as well as monetize from very specific advertising opportunities without needing a physical infrastructure. Location owners receive an electronic communication conduit to visitors, monetization opportunities, alerts to unauthorized signals, and app functionality enhancements.

Advertising Optimization and Retargeting from the Real Life Conversion Pixel

In addition to using signals to deliver various types of value to a user inside a location, those signals may be part of a chain of events to deliver value beginning before and/or stretching after the mobile device has left the location. There are many opportunities to use such signals to connect online and offline advertising, to serve more relevant advertising, information, and communication to consumers, and to optimize current advertising and communication on based on effectiveness metrics made possible by the signals.

In digital advertising, retargeting is the practice of identifying a consumer who visited a certain webpage—such as a homepage, a product page, or a shopping cart page—then messaging that same consumer at a later time, sometimes on a different website. We can use signals like those described above to apply the system of website retargeting into the physical real world. In one embodiment, a consumer entering a store and encountering one or more signals could have their device ID tagged with information on the stores visited, areas browsed, time spent, and/or products they were interested in. This information may be stored at a location locally, on a mobile device, and/or on a server. While that user is in the store, and/or after they have left, the advertising they see can be targeted based on the data gathered. This targeting can recognize the data gathered, such as which store was entered, browse time in the electronics department, or even time spent in front of a particular item, such as a particular big screen TV model in the store.

On many mobile devices, unique identifiers and tags between the operating system and web browser are kept separated. It is difficult to match information, match data, and respect privacy options, such as do not track preferences, gathered between separate systems, such as apps, mobile web browsers, and other devices such as desktop computers and additional mobile devices, such as second phones, iPads™ and others. Detecting the signals as described herein typically occurs at the operating system level in mobile devices and is accessible to apps. A significant amount of user time and a large amount of advertising occurs outside of the initial apps and operating system where the signals are detected, such as in a mobile web browser on the same phone, in another mobile device, or in a web browser on another computer. Value can be created by mapping the signals and associated data across devices for the same user, the same household, the same co-workers, and/or the same family.

To link signals with user value outside of the initial signal trigger, in one embodiment, a system consisting of one or more of a locally deployed signals, a mobile device, and a web browser on that device exists. In that system, the signal triggers the web browser to open and carries an identifier into the mobile web browser. That identifier can be an array of one or more variables and they may be passed through the Uniform Reference Locator (URL) string. Once the browser is open, the website might set or update a cookie with those variables. In another embodiment, a device can assemble an imprint of the device variables, such as configuration settings, IP address, installed plugins, fonts installed, etc. and keep a version of that imprint on a server. When other devices or web browsers detected from the same user fit that imprint with a threshold of certainty, the new device or browser can be added. This imprint can be run through an app directly, in a browser window within an app, and/or through an app directly. Similarly, a web browser can trigger an app (commonly called an intent call in mobile development) and pass data to that app enabling the website to initiate the synching herein described from mobile to app.

In another embodiment, this technology can be used beyond stores to other physical locations that can provide context, such as bars, gyms, sporting events, and festivals. The aforementioned list is not meant to be all-inclusive, the technology can be used anywhere where mobile device users, consumers, or the like move about in the physical world.

The mobile device value delivery network as described herein can be augmented with additional data tied back to the device including purchases, loyalty information, demographic data, and behavioral data. All data points can be used predictively to understand what factors lead to success with advertising. Purchase data can help show the efficacy of the ads as well as when to stop advertising for a particular department or product because the success metric, such as the purchase of a particular product, has been achieved.

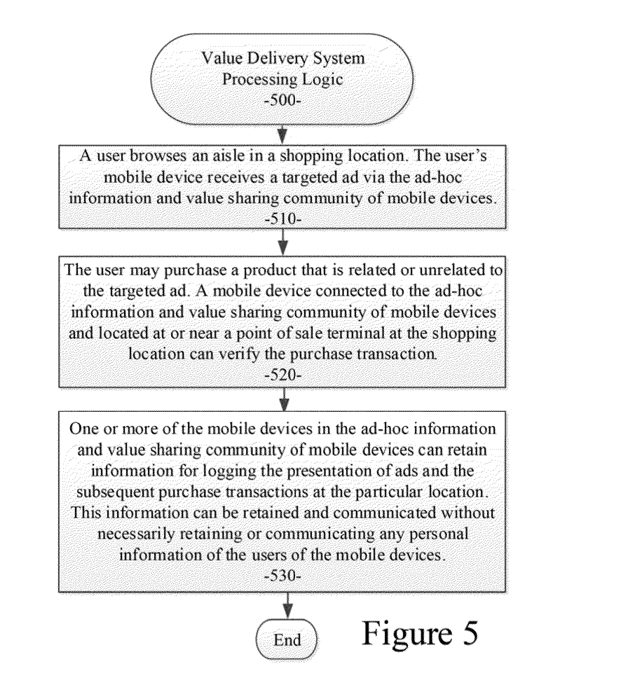

One way to get purchase data, yet not personally identify the user, is to use signal devices in close proximity to checkout registers. In this way, a user purchase can be confirmed. In addition, via the point of sale system, the specific products purchased can be attributed to that device. This can be done without transmitting the shopper's name, address, credit card, or any other personally identifiable information. For example as shown in FIG. 5, an example embodiment includes a process 500 for collecting valuable information related to the presentation of ads and the purchase of products in a shopping location, without collecting personal information.

In one embodiment, an advertiser may target their own shoppers, or those who shopped in a competitive or complementary manner. An example of competitive advertisers would be Starbucks™ and Dunkin Donuts™; a consumer wanting coffee would choose one or the other, not both. An example of complementary advertisers would be Ikea™ and Home Depot™; a person shopping at Ikea for new furniture might also be in the market for paint and home goods from Home Depot™.

In yet another embodiment, a network can be used to tag devices without needing a fixed signal-emitting device at the location, or even permission of the location itself. In this method, inputs like GPS signals, coordinates inferred from WiFi triangulation, and other distinguishing characteristics of networks existing at physical locations are used to tag, sort, and specifically target consumers for advertising and communications purposes. This allows competitive targeting and precise location based targeting without necessitating the cooperation of the location itself.

### Conversion Tracking

Virtually all online media is now purchased against metrics to determine effectiveness. Because many purchases occur online, advertisers can track the impact of their ads directly against sales using methods such as cookies. For offline brands and retailers, performance metrics against online media campaigns are less clear. Click through rate of an ad, which can be gamed or defrauded, is commonly used. Using locally deployed signals as a mechanism to confirm shopper behavior allows advertisers to give attribution to online media campaigns based on offline actions such as a location visit or product purchased.

In one embodiment of the system and methods described herein, locally deployed signals are used to confirm a pre-determined, spontaneous, or ad hoc conversion event. Such events can range from a mobile electronic device entering and moving within and between specific regions in space and/or time. A region can be broadly defined as any pre-determined area in space and/or time. An event can also include a mobile electronic device maintaining its position within a specific region for a given amount of time, or following a recognized pattern through multiple regions. As described in more detail herein, a mobile electronic device can be defined generally as any device with a local data processor and memory. Further, an event can be triggered by a user declared action 162 or system event (1st event), taken together in combination with the coordinated or related occurrence of a second event 164 (movement within and between regions) as described above. Examples of a user declared action 162 (1st event) include actions within an application on a mobile electronic device, such as declaring location via a check-in, scanning any type of physical media, including receipts, barcodes, and QR codes, or actions outside of the application, including interacting with a Point of Sale (POS) system in either an analog or digital manner. Another example of a 1st event would be a mobile device user receiving a confirmation email for an offline purchase. In this case, the purchase confirmation travels from the location's POS system, to the user's mobile device, which is then read by an application on the mobile device and recorded as a 1st event.

In another example, a user may view a banner ad for a new brand of razor while browsing a site on their mobile device. The presentation of the banner ad on the user's mobile device can be recorded as a 1st event with an associated identifier. Though the user never clicks the banner ad, the user subsequently goes to a store, stands in the razor section of the store with their mobile device, and buys the razor promoted by the previously viewed banner ad. The purchase transaction can be recorded as a 2nd event with another associated identifier. In this situation within pre-determined boundaries of space and time, we can infer that the user viewing the banner ad (1st event) inspired the user to the purchase the promoted product (2nd event). Through tracking the first event and linking or correlating the first event with subsequent events, we can create a better system for evaluating an ad's effectiveness and a better system for creating causal links between events.

In this embodiment, a fixed electronic device (fixed device) or a plurality of fixed devices at the location broadcasts signals. Mobile devices, or clients, in the vicinity of the fixed devices receive these signals and perform analysis locally and/or pass the signals to an external server via wide area network 120 for further analysis. The analysis is performed using logic/processes to determine which, if any, events have occurred. If an event has occurred, an event identifier, along with the device identifier associated with the mobile device, can be passed via wide area network 120 to either an internal or external advertising platform or server (e.g., ad server 123. Here, the device identifier and event identifier are matched against pre-existing impression/click data (individually identified by device identifier) from online media campaigns. This gives performance attribution to online media campaigns from offline or hybrid online/offline conversion events.

### Example

A big box store is running an online media campaign to drive in-store traffic. A mobile device user views and clicks on an ad placement (e.g., a banner advertisement on a mobile device) from the big box campaign on the user's mobile device. As a result, the Ad Server/Network records the user's mobile device identifier, identifying the user as someone who has seen and interacted with the advertisement (1st identification). A short period later, the user drives past the big box store, remembers the advertisement, and decides to walk in. As the user walks into the store, the user's mobile device picks up the signal being broadcast by the fixed device at the location and passes the signal to the server along with its device identifier. The server identifies the data passed from the client as a conversion event (2nd identification), and passes the event identifier along with the device identifier to the Ad Server/Network. By matching the 2nd identification to the 1st identification using the device identifier, the Ad Server/Network can attribute this conversion event to the specific online media campaign that triggered it, providing valuable performance indicators and optimization potential for advertisers. The system can create value by mapping the signals and associated data across devices for the same user, the same household, the same co-workers, and/or the same family.

### Other Features

Traditional desktop cookie technologies are well known in the art. With the emergence of mobile technologies, specifically the fragmentation of consumer attention across multiple devices and consumption mediums, it has become necessary to be able to identify consumers across multiple devices and/or attribute activity from multiple devices to a single cross-device profile. One way to consolidate user profiles across multiple devices is to use IP tethering. In this method, multiple devices connected to the same IP address can be grouped into user profiles, which can then be further used for targeting, conversion tracking, and analytics. For example, if a consumer was exposed to a Toyota advertisement on their desktop PC, their browser might have created a cookie with that information. Because the consumer also accesses his mobile device from the same IP address as his desktop PC, the two devices would be tethered together under one user profile, and activity from both devices would be mapped to a single user profile. The consumer could then walk with his mobile device into a Toyota™ dealership, triggering a conversion event, as described above. That conversion event could ultimately be mapped from the device identifier, to the cross-device profile, to the initial event for which a cookie was created. This means that conversion events recorded from one device can be mapped to initial impressions or actions on a separate, cookie-enabled device.

A second way to consolidate user profiles across multiple devices is through statistical/probabilistic methods. In this method, a server side process analyzes common parameters and attributes passed by various devices (e.g., clients) in order to find correlations across multiple devices, thereby attributing those devices to the same user. Parameters such as WiFi signal, IP address, timestamp, operating system, location, and type of content consumed can be used, along with a host of other factors. The preceding list is not meant to be all-inclusive. By finding correlations in common parameters passed from device (e.g., client) to server, cross-device profiles can be determined with a degree of accuracy. These cross-device profiles can be used to link activity between devices. In the case of the value delivery network as described herein, the transmission of signals among mobile devices can be used for linking conversion events from one device to advertising impressions and interactions on a second or even third device in order to give advertisers a measure of advertising performance or a mechanism for retargeting advertising across devices.

A third way to consolidate user profiles across multiple devices is through deterministic attribution by way of a single, cross-device log-in or user account. When a user is logged into a singular account across a myriad of devices, the singular account provides the bridge to connect each device. By this way, actions tracked on each device can be combined into a single profile, giving advertisers the ability to track both cross-device conversions as well as implement cross-device remarketing campaigns. One example would be to use another login such as Facebook™ or Google™ logins to tie multiple devices or browsers to the same user.

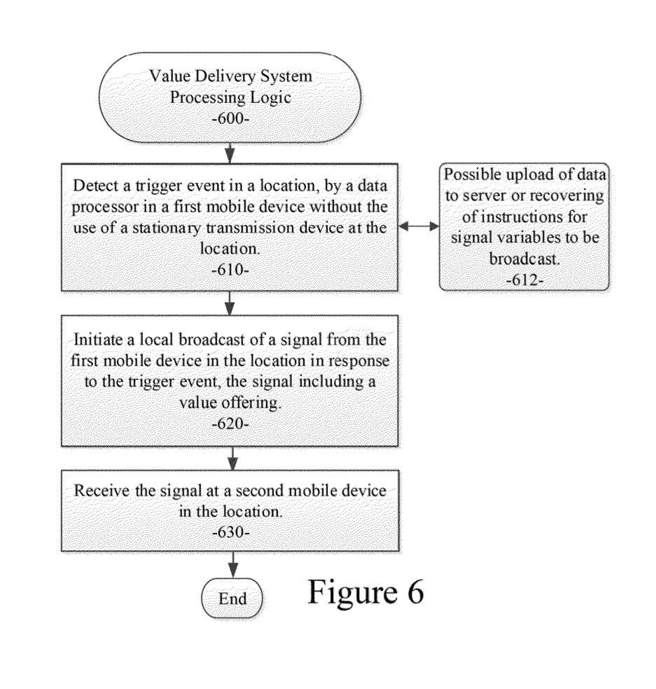

Referring now to FIG. 6, a processing flow diagram illustrates an example embodiment of a method 600 for value delivery as described herein. The method 600 of an example embodiment includes: detecting a trigger event in a location, by a data processor in a first mobile device without the use of a stationary transmission device at the location (processing block 610); optionally performing an upload of data to a server or recovering of instructions for signal variables to be broadcast (processing block 612); initiating a local broadcast of a signal from the first mobile device in the location in response to the trigger event, the signal including a value offering (processing block 620); and receiving the signal at a second mobile device in the location (processing block 630).

In various embodiments as described herein, other example embodiments can include at least the following examples.

A non-transitory machine-useable storage medium embodying instructions which, when executed by a machine, cause the machine to: detect a trigger event in a location, by a data processor in a first mobile device without the use of a stationary transmission device at the location; initiate a local broadcast of a signal from the first mobile device in the location in response to the trigger event, the signal including a value offering; and receive the signal at a second mobile device in the location.

The machine-useable storage medium as claimed above wherein the first mobile device and the second mobile device are from the group consisting of: personal communication devices, cellular telephones, smartphones, wireless devices, portable computing devices, laptops, tablet computers, personal digital assistants (PDAs), wearable computing devices, network computers, web appliances, networking devices, routers, gateways, personal computers (PCs), set-top boxes, consumer electronic devices, vehicle electronic systems, a data processing system, a communication system, a networking system, and an electronic system.

The machine-useable storage medium as claimed above wherein the value includes a record of visits for marketing conversions or remarketing.

A system comprising: a data processor in a mobile device; and a value delivery system, executable by the data processor, to: detect a first event associated with a user of the mobile device, by the data processor in the mobile device; record a first identifier associated with the first event; subsequently detect a second event associated with the user of the mobile device, by the data processor in the mobile device; record a second identifier associated with the second event; correlate the first event and the second event using the first identifier and the second identifier; and deliver a value offering if the first event and the second event are correlated.

The system as claimed above wherein the mobile device is from the group consisting of: personal communication devices, cellular telephones, smartphones, wireless devices, portable computing devices, laptops, tablet computers, personal digital assistants (PDAs), wearable computing devices, network computers, web appliances, networking devices, routers, gateways, personal computers (PCs), set-top boxes, consumer electronic devices, vehicle electronic systems, a data processing system, a communication system, a networking system, and an electronic system.

The system as claimed above wherein the first event includes a user-initiated event or an automatic event.

The system as claimed above wherein the value offering includes at least one element from the group consisting of: advertising, a coupon, application (app) functionality, loyalty points, and a record of visits for at least one of: marketing, conversions, or remarketing.

A system comprising: a first data processor in a first electronic device; a second data processor in a second electronic device; and a value delivery system, executable by the second data processor, to: receive data corresponding to a first event associated with a user of the first electronic device, by the data processor in the second electronic device; record a first identifier associated with the data corresponding to the first event; detect a second event associated with the user of the second electronic device, by the data processor in the second electronic device; record a second identifier associated with the second event; correlate the first event and the second event using the first identifier and the second identifier; and deliver a value offering if the first event and the second event are correlated.

The system as claimed above wherein the second electronic device is from the group consisting of: personal communication devices, cellular telephones, smartphones, wireless devices, portable computing devices, laptops, tablet computers, personal digital assistants (PDAs), wearable computing devices, network computers, web appliances, networking devices, routers, gateways, personal computers (PCs), set-top boxes, consumer electronic devices, vehicle electronic systems, a data processing system, a communication system, a networking system, and an electronic system.

The system as claimed above wherein the first event includes a user-initiated event or an automatic event.

The system as claimed above wherein the value offering includes at least one element from the group consisting of: advertising, a coupon, application (app) functionality, loyalty points, and a record of visits for at least one of: marketing, conversions, or remarketing.

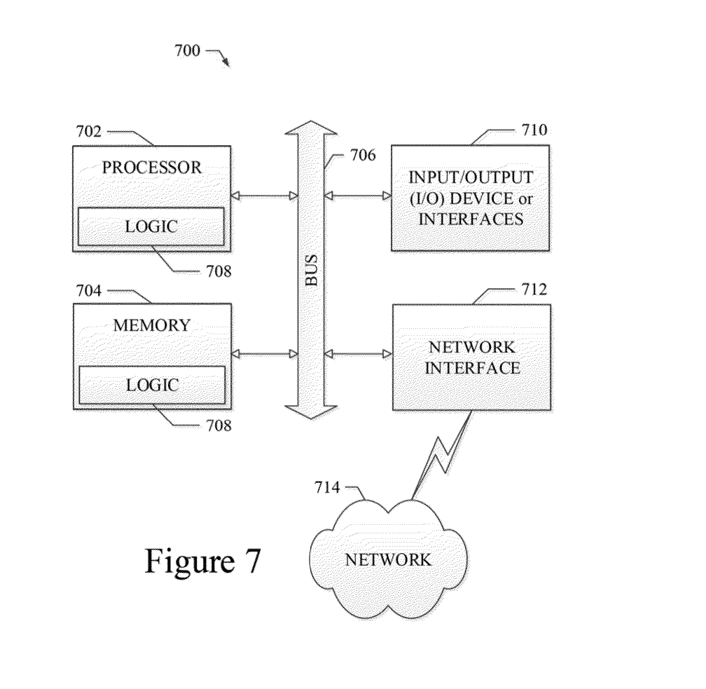

FIG. 7 shows a diagrammatic representation of a machine in the example form of a stationary or mobile computing and/or communication system 700 within which a set of instructions when executed and/or processing logic when activated may cause the machine to perform any one or more of the methodologies described and/or claimed herein. In alternative embodiments, the machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a laptop computer, a tablet computing system, a Personal Digital Assistant (PDA), a cellular telephone, a smartphone, a web appliance, a wearable computing or communication device, a set-top box (STB), a network router, switch or bridge, or any machine capable of executing a set of instructions (sequential or otherwise) or activating processing logic that specify actions to be taken by that machine. Further, while only a single machine is illustrated, the term “machine” can also be taken to include any collection of machines that individually or jointly execute a set (or multiple sets) of instructions or processing logic to perform any one or more of the methodologies described and/or claimed herein.

The example stationary or mobile computing and/or communication system 700 includes a data processor 702 (e.g., a System-on-a-Chip (SoC), general processing core, graphics core, and optionally other processing logic) and a memory 704, which can communicate with each other via a bus or other data transfer system 706. The stationary or mobile computing and/or communication system 700 may further include various input/output (I/O) devices and/or interfaces 710, such as a monitor, touchscreen display, keyboard or keypad, cursor control device, voice interface, and optionally a network interface 712. In an example embodiment, the network interface 712 can include one or more network interface devices or radio transceivers configured for compatibility with any one or more standard wired network data communication protocols, wireless and/or cellular protocols or access technologies (e.g., 2nd (2G), 2.5, 3rd (3G), 4th (4G) generation, and future generation radio access for cellular systems, Global System for Mobile communication (GSM), General Packet Radio Services (GPRS), Enhanced Data GSM Environment (EDGE), Wideband Code Division Multiple Access (WCDMA), LTE, CDMA2000, WLAN, Wireless Router (WR) mesh, and the like). Network interface 712 may also be configured for use with various other wired and/or wireless communication protocols, including TCP/IP, UDP, SIP, SMS, RTP, WAP, CDMA, TDMA, UMTS, UWB, WiFi, WiMax, Bluetooth, IEEE 802.11x, and the like. In essence, network interface 712 may include or support virtually any wired and/or wireless communication mechanisms by which information may travel between the stationary or mobile computing and/or communication system 700 and another computing or communication system via network 714.

The memory 704 can represent a machine-readable medium on which is stored one or more sets of instructions, software, firmware, or other processing logic (e.g., logic 708) embodying any one or more of the methodologies or functions described and/or claimed herein. The logic 708, or a portion thereof, may also reside, completely or at least partially within the processor 702 during execution thereof by the stationary or mobile computing and/or communication system 700. As such, the memory 704 and the processor 702 may also constitute machine-readable media. The logic 708, or a portion thereof, may also be configured as processing logic or logic, at least a portion of which is partially implemented in hardware. The logic 708, or a portion thereof, may further be transmitted or received over a network 714 via the network interface 712. While the machine-readable medium of an example embodiment can be a single medium, the term “machine-readable medium” should be taken to include a single non-transitory medium or multiple non-transitory media (e.g., a centralized or distributed database, and/or associated caches and computing systems) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A computer-implemented method comprising:
detecting a trigger event in a location, by a data processor in a first mobile device without the use of a stationary transmission device at the location;
initiating a local broadcast of a signal from the first mobile device in the location in response to the trigger event, the signal including a value offering; and
receiving the signal at a second mobile device in the location.

2. The method of claim 1 wherein the first mobile device and the second mobile device are from the group consisting of: personal communication devices, cellular telephones, smartphones, wireless devices, portable computing devices, laptops, tablet computers, personal digital assistants (PDAs), wearable computing devices, network computers, web appliances, networking devices, routers, gateways, personal computers (PCs), set-top boxes, consumer electronic devices, vehicle electronic systems, a data processing system, a communication system, a networking system, and an electronic system.

3. The method of claim 1 wherein the trigger event includes a user-initiated event or an automatic event.

4. The method of claim 1 wherein the value includes at least one element from the group consisting of: advertising, a coupon, application (app) functionality, loyalty points, and any combination of the elements.

5. The method of claim 1 further including terminating the local broadcast when the first mobile device exits the location, and enabling other mobile devices at the location to perpetually sustain the signal.

6. The method of claim 1 further including using decoy signals that only authorized receivers can differentiate from authentic.

7. The method of claim 1 further including using variably modulated codes that only authorized receivers can decipher, alter, and/or replicate.

8. The method of claim 1 further including mapping signal generators and identifying unauthorized signals in the location using ad hoc connected mobile devices.

9. The method of claim 1 wherein the value includes a record of visits for marketing conversions or remarketing.

10. The method of claim 1 wherein the first mobile device has access to a wide area network.

11. A system comprising:
a data processor in a first mobile device;
an ad-hoc local network interface, in data communication with the data processor, for communication on an ad-hoc local data network; and
a value delivery system, executable by the data processor, to:
detect a trigger event in a location, by the data processor in the first mobile device without the use of a stationary transmission device at the location;
initiate a local broadcast of a signal from the first mobile device in the location in response to the trigger event, the signal including a value offering; and
receive the signal at a second mobile device in the location.

12. The system of claim 11 wherein the first mobile device and the second mobile device are from the group consisting of: personal communication devices, cellular telephones, smartphones, wireless devices, portable computing devices, laptops, tablet computers, personal digital assistants (PDAs), wearable computing devices, network computers, web appliances, networking devices, routers, gateways, personal computers (PCs), set-top boxes, consumer electronic devices, vehicle electronic systems, a data processing system, a communication system, a networking system, and an electronic system.

13. The system of claim 11 wherein the trigger event includes a user-initiated event or an automatic event.

14. The system of claim 11 wherein the value includes at least one element from the group consisting of: advertising, a coupon, application (app) functionality, loyalty points, and any combination of the elements.

15. The system of claim 11 being further configured to terminate the local broadcast on the first mobile device when the first mobile device exits the location and enabling other mobile devices at the location to perpetually sustain the signal.

16. The system of claim 11 being further configured to use decoy signals that only authorized receivers can differentiate.

17. The system of claim 11 being further configured to use variably modulated codes that only authorized receivers can decipher, alter, or replicate.

18. The system of claim 11 being further configured to map signal generators and identify unauthorized signals in the location.

19. The system of claim 11 wherein the value includes a record of visits for marketing, conversions, or remarketing.

20. The system of claim 11 wherein the first mobile device has access to a wide area data network.
